(19) United States
(12) Patent Application Publication
(10) Pub. No.: US 2024/0403984 A1
(43) Pub. Date: Dec. 5, 2024

(54) SYSTEMS AND METHODS FOR PROTECTING PROPRIETARY DATA WHILE USING THIRD-PARTY AI/ML SERVICES

(71) Applicant: LNRS Data Services Inc., Alpharetta, GA (US)

(72) Inventor: Kevin Hightower, Charolette, NC (US)

(21) Appl. No.: 18/637,545

(22) Filed: Apr. 17, 2024

Related U.S. Application Data
(60) Provisional application No. 63/505,524, filed on Jun. 1, 2023.

(51) Int. Cl. G06Q 50/18; G06F 21/62

(52) U.S. Cl. CPC G06Q 50/184; G06F 21/6218

(57) ABSTRACT

Systems and methods are provided for utilizing AI/ML services to solve business problems while protecting proprietary information. Third-party AI/ML services are utilized in a multi-stage approach to answer a question and/or or solve a problem, create code to validate the answer, execute that code inside a proprietary system, and then use that answer to create a better answer without exposing proprietary data to a third-party.

### CROSS-REFERENCE TO RELATED APPLICATIONS

This application claims priority to U.S. Provisional Patent Application No. 63/505,524, filed 1 Jun. 2023, the contents of which are incorporated herein by reference as if presented in full.

### FIELD

The disclosed technology generally relates to protecting proprietary data, and in particular, to systems and methods for protecting proprietary data while using third-party artificial intelligence and/or machine language services.

### BACKGROUND

The rise in ChatGPT and other artificial intelligence and/or machine language (AI/ML) services presents tremendous opportunities for businesses to streamline internal operations, build new products, and/or provide efficient service for customers. However, there is a risk that an unrefined baseline AI/ML service used to answer a business-specific question can output hallucinations, which can include (very confident) wrong answers, particularly when numbers and analytics are involved.

FIG. 1 depicts a general process 100 for fine-tuning an AI/ML model so that hallucinations can be avoided, and so that the (refined) model may be suitable for being hosted on a business server. The blocks 102, 106, and 108 may include proprietary data or sensitive customer data. Blocks 104 and 110 represent processes performed using a third-party service. This process 100 can include a “pre-processing” phase where in block 102, proprietary data and business logic may be formulated into a format for fine tuning. In block 102, a baseline model may be fine-tuned using third-party AI/ML services. In certain instances, the proprietary data may be used in such a way that the resulting model 105 may be used for a specific business purpose. In a typical use, and as shown in block 106, a problem, question, or change in proprietary data may be entered in a proprietary system. In block 108, the proprietary system may formulate a prompt (including any seed parameters). In block 110, the prompt may be sent to the third-party service, which may utilize the fine-tuned model 105 to answer the question. However, this process 100 can risk passing proprietary data to the third-party where it is no longer in the creating business's control, raising security, privacy, and competitive concerns. Additionally, every time there is a new service or updated model, the training process may need to be repeated at a significant expense.

An example alternative to the above-referenced process 100 for fine-tuning a model could include creating a “safe model” for hosting without interfacing with a third-party service. However, such a model may not be complete in content, or it may not have the same desirable features as the third-party services. There is a need for a process and system that will allow creating and/or fine-tuning a business-accurate AI/ML model with desirable third-party features without exposing proprietary data.

### BRIEF SUMMARY

Some or all of the above needs may be addressed by certain embodiments of the disclosed technology. Certain embodiments of the disclosed technology may include using a multi-stage approach with third-party AI/ML model to answer a query, create code to validate the answer, execute that code inside a proprietary system, and then use that answer to create a better answer.

In certain implementations, one or more hallucinations to certain queries may be determined, for example, by internal operations, by a customer asking a question, or other automated means. In certain implementations, a question may be formulated, and certain pre-seed parameters may be created. The process may utilize a third-party AI/ML service to answer the question, and the results may be parsed for possible hallucinations to be validated by data that exists in the proprietary system(s). The process may re-formulate the AI/ML answer into a coding question. Then pre-seed parameters using the proprietary system schemas/baselines may be generated. The third-party service may be used again to answer the coding question. The process may validate the coding response for security/privacy/performance, and a coding response may be executed in the proprietary systems. In certain implementations, the original question may be re-formulated to include the results of the proprietary execution and the third-party service may be used to answer the original question with the data from the result. In certain implementations, the results may be validated to ensure they meet acceptable quality levels.

In accordance with certain exemplary implementations of the disclosed technology, a method is provided for utilizing AI/ML services to solve business problems while protecting proprietary information. The method can include one or more of the following steps: identifying a question to be answered; formulating a prompt based on the question; submitting the prompt to a third-party AI/ML service; receiving an initial answer to the question based on the submitted prompt; validating the initial answer against data in a proprietary system; reformulating a validated initial answer into a coding question; submitting the coding question to the third-party AI/ML; receiving, from the third-party AI/ML service, a coding response to the coding question; executing the coding response in the proprietary system to generate a proprietary response; validating the proprietary response for one or more of security, privacy, performance, and accuracy against data in the proprietary system; creating a reformulated prompt based on the question and a validated proprietary response; submitting the reformulated prompt to the third-party AI/ML service; receiving final results from the third-party AI/ML service; and validating the final results based on predetermined criteria.

Certain implementations of the disclosed technology can include a system having memory for storing instructions, and a processor that can execute the instructions to perform one or more of the steps in the above-referenced method.

Certain implementations can include non-volatile computer readable memory that stores instructions that, when executed by a processor, perform one or more of the steps in the above-referenced method.

Other embodiments, features, and aspects of the disclosed technology are described in detail herein and are considered a part of the claimed disclosed technologies. Other embodiments, features, and aspects can be understood with reference to the following detailed description, accompanying drawings, and claims.

### BRIEF DESCRIPTION OF THE FIGURES

Reference will now be made to the accompanying figures and flow diagrams, which are not necessarily drawn to scale, and wherein:

FIG. 1 is a block diagram of a standard fine-tuning process 100 for a model.

FIG. 2 is an illustrative multi-stage process 200 for fine-tuning a model, in accordance with certain exemplary implementations of the disclosed technology.

FIG. 3 depicts an example process 300 for a use case, according to certain exemplary implementations of the disclosed technology.

FIG. 4 is a block diagram of an illustrative computing system 400, according to an exemplary embodiment of the disclosed technology.

FIG. 5 is a flow diagram of a method 500 according to an exemplary embodiment of the disclosed technology.

FIG. 6 is a flow diagram of a method 600 according to an exemplary embodiment of the disclosed technology.

### DETAILED DESCRIPTION

Embodiments of the disclosed technology will be described more fully hereinafter with reference to the accompanying drawings, in which certain example embodiments are shown. This disclosed technology may, however, be embodied in many different forms and should not be construed as limited to the embodiments set forth herein; rather, these embodiments are provided so that this disclosure will be thorough and complete, and will fully convey the scope of the disclosed technology to those skilled in the art.

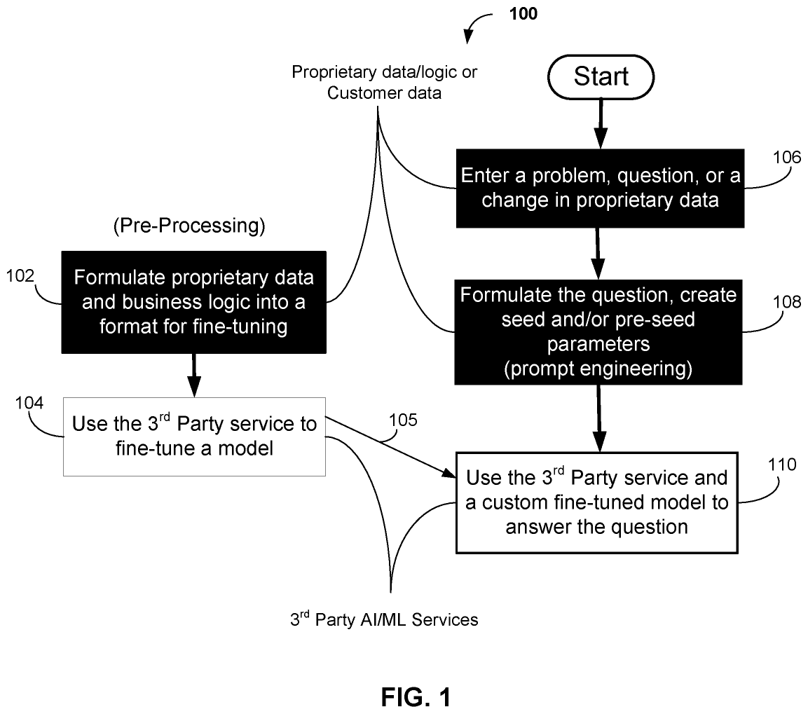

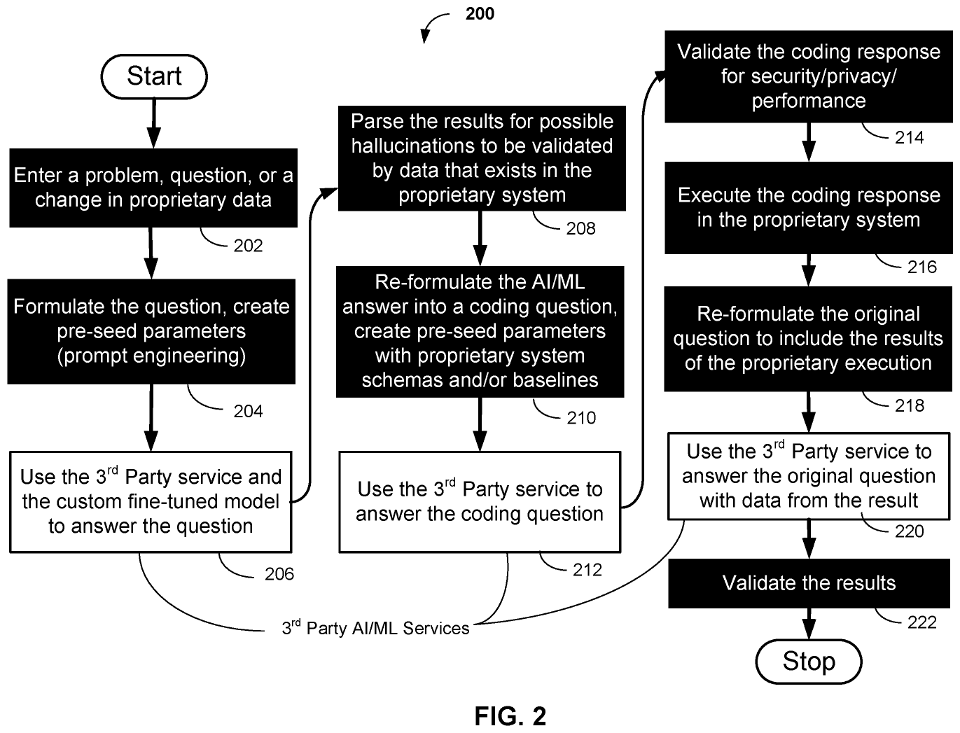

The disclosed technology can provide an alternative and/or improvement to the less-secure process of model fine-tuning, as described above and shown in FIG. 1. FIG. 2, for example, depicts an exemplary embodiment of the disclosed technology, which may enable the utilization of third-party AI/ML services in a multi-stage approach to answer a question and/or or solve a problem, create code to validate the answer, execute that code inside proprietary systems, and then use that answer to create a better answer-without exposing proprietary data to a third-party.

According to exemplary embodiments, and with reference to FIG. 2, certain implementations of the disclosed technology may use baseline AI/ML services to solve a problem and/or answer a question. In certain implementations, the results (including hallucinations) may be analyzed, reformulated, and then fed to an AI/ML service to identify the actual code that would need to be run to get the correct answers or solution. In certain implementations, a business may run such actual code in their own protected, proprietary environment. Once the answers are received, the result may be fed back to the AI/ML services to complete the answer/solution without the hallucinations and without sharing proprietary data and/or algorithms with the third party.

In accordance with certain implementations, and with reference to the process 200 illustrated in FIG. 2, blocks 206, 212, and 220 may be processed using a third-party AI/ML service, while the remaining blocks 202, 204, 208, 210, 214, 216, 218, and 222 may be performed using a proprietary system so that sensitive or proprietary information or algorithms are not exposed to the third-party AI/ML service. In block 202, a problem, question, and/or change in proprietary data may be entered into a proprietary system. In this step, the associated issue related to the problem, question, and/or change can be found in several ways, including automated means. For example, a customer may ask a question of the business who operates a private/proprietary system. In certain implementations, the question may be in the form of a chat, email, voice, etc. In certain implementations, the question may be extracted automatically for further use in the process 200. In situations where the business needs to change or update the proprietary data on their system, the corresponding change in the proprietary data may be entered into the proprietary system.

In block 204, the problem, question, and/or change in proprietary data may be formulated into a prompt. In certain implementations, the prompt can include seed parameters (i.e., parameters to the question based on the dynamic results of the initial questions(s)) and/or pre-seed parameters (i.e. parameters to the question based on the proprietary data structures, proprietary definitions, or other proprietary information known before the question is asked), for example, that can help in guide the AI/ML towards generating content that aligns more closely with a desired topic without being overly prescriptive. In certain implementations, block 204 can utilize prompt engineering, in which seed words (or numbers) may be strategically included to guide the AI/ML in generating content that aligns more closely with a desired topic. In certain implementations, the prompt engineering may enable meticulous control over AI/ML models via well-defined prompts, which can direct the AI/ML systems to yield outputs aligned with specific objectives, while the seed words can provide flexibility and creative breadth. Certain implementations of the disclosed technology may utilize seeds and/or pre-seeds to steer the AI/ML in a particular direction, encouraging a variety of potential responses, which can be beneficial in scenarios requiring creativity and exploration. In certain implementations, the formulated prompt may be scrubbed of any proprietary or sensitive information.

In block 206, a model on a third-party AI/ML service may be fine-tuned, for example, by training the model on a targeted data set. In certain implementations, the original capabilities of a pretrained model may be maintained while it is adapted to suit more specialized use cases. In certain implementations, training/fine-tuning the model can help improve performance and accuracy over a wide range of tasks. In certain implementations, training data may be structured with each line representing a prompt-completion pair corresponding to a training example. In certain implementations, a command line interface (CLI) data preparation tool may be utilized to validate, provide suggestions, and reformat data into the required format for fine-tuning. In accordance with certain exemplary implementations of the disclosed technology, the prompt (as formulated in block 204) may be submitted to the (fine-tuned) AI/ML model and resulting answer may be captured.

In block 208, the resulting answer from block 206 may be parsed for possible hallucinations. In certain implementations, the data that exists in the proprietary system may be used to validate the answer and/or to determine if the resulting answer includes any hallucinations. One approach that may be used to reduce hallucinations is the Retrieval-Augmented Generation (RAG) model in conjunction with vector databases. This approach may enable efficient leveraging of large language models (LLM) with proprietary data. In accordance with certain exemplary implementations of the disclosed technology, a trusted knowledge source (i.e., data from the proprietary system) may be searched for relevant data. The model may use those results to generate a user-friendly response and consolidate the pertinent details into a single concise answer. In certain implementations, vector databases may be used to improve the performance of the RAG model. In certain implementations, vector databases may store text as embeddings, or numerical vectors that capture its meaning. Questions may also be converted into a numerical vector. Relevant documents or passages can then be found in the vector database, even when they don't share the same words. This approach can be used to mitigate the risk of hallucinations that can occur when relying on the AI/ML/LLM model to generate answers solely from its training data.

In block 210, the process 200 may re-formulate the AI/ML answer into a coding question and create pre-seed parameters with proprietary system schemas/baselines. For example, this step may utilize the results of an AI/ML answer to change it into a coding problem based on proprietary schemas, baseline products, code, and/or processes without sharing the actual proprietary data to a third-party. In certain implementations, a schema may be a set of database definitions captured at a specific time. In certain implementations, a baseline version of a schema may be the initial version of the database schema and may be used to help create full visibility of a schema's evolution. In certain implementations, the baseline may be a static representation of a project, and thus can be used as a benchmark against which to measure performance as the project progresses. In certain implementations, multiple baselines may be created to establish metrics throughout the project life cycle.

In block 212, the third-party AI/ML service may be used to answer the coding question (as formulated in block 210). In this step, the process of asking a coding question based on previous responses combined with business information may be done without sharing the actual proprietary data. In this step, the third-party AI/ML service may output a coding response.

In block 214, the proprietary system may validate the coding response for security, privacy, and/or performance. In certain implementations, processes similar to the ones described above in block 208 may be employed to validate the coding response.

In block 216, the validated coding response may be executed in the proprietary system. In this step, using the results of an AI/ML coding response (based on the previous steps) may enable the AI/ML model to run on a company's own proprietary systems.

In block 218, the original question may be re-formulated to include the results of the proprietary execution from block 216.

In block 220, the third-party service may be used to answer the reformulated original question with the data from the results. In this step, asking a question may be based on the previous steps.

In block 222, the proprietary system may validate the results to ensure they meet acceptable quality levels. In certain implementations, the acceptable quality levels may be based on certain metrics and/or predetermined thresholds. In certain implementations, processes similar to the ones described above in block 208 may be employed to validate the result.

As can be recognized by those having ordinary skill in the art, the disclosed technology can provide improvements over traditional systems, allowing use of third-party AI/ML services while reducing or eliminating exposure of proprietary data and/or proprietary processes with third parties.

Certain implementation of the disclosed technology may further reduce costs. For example, the disclosed technology does not require third-party fine-tuning, which can be a costly step, and it may allow migration between AI/ML services (either different versions or different companies) without having to re-invest in fine-tuning or other costly integration steps.

Certain implementation of the disclosed technology may provide improvements in flexibility. For example, the code generation step can be in the SQL language to run in proprietary databases, or code to execute within systems. Certain implementations may create surveys or other tools to collect information from customers in proprietary systems without sharing the data. In certain implementations, the full process may be automated to run in seconds or over a predetermined time period (such as months, for example) with collection of external user input as part of the steps.

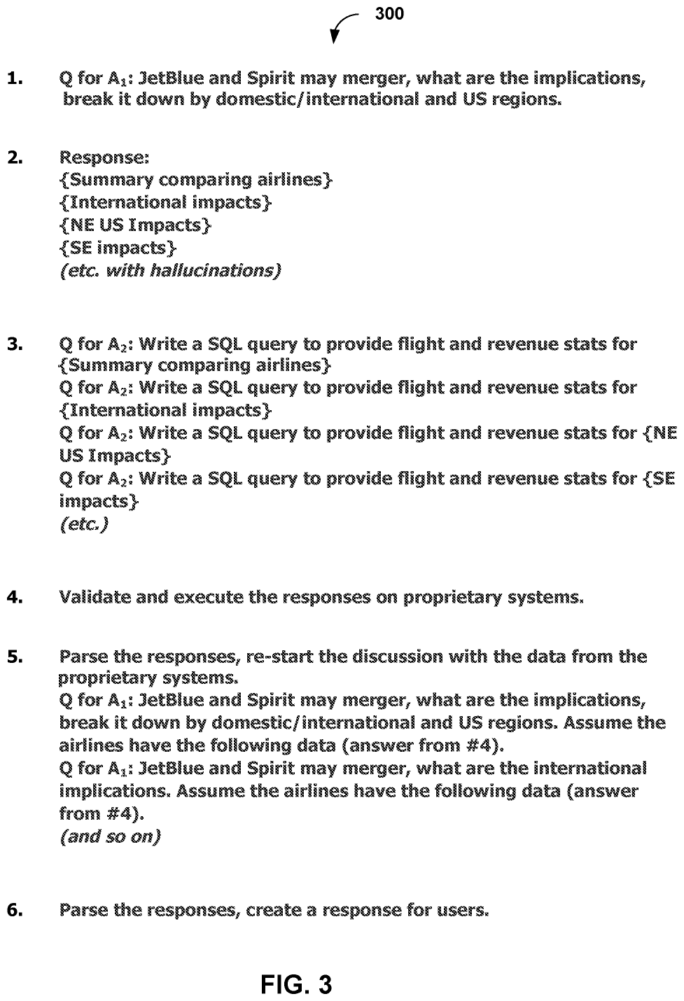

FIG. 3 depicts a use case of an example process for determining implications of a merger between two airlines. According to certain exemplary implementations of the disclosed technology, the example use case may follow some or all of the steps discussed above with respect to FIG. 2. In step (1), a query (Q) may be formulated (for example, using a proprietary system) and posed to a third-party AI/ML system (A₁) to ask what the implications would be if two airlines merged. The query can include the request to break down the results by domestic, international, and US regions.

In step (2) the results received from the third-party AI/ML system may be parsed, checked for hallucinations, and validated by the proprietary system.

In step (3) the results received from the third-party AI/ML system may be reformulated (by the proprietary system) into coding questions for the third-party AI/ML system (A₂) to generate.

In step (4) the coding questions generated by the third-party AI/ML system (A₂) may be validated and the generated coding questions may be executed on the proprietary system (A₁).

In step (5), the responses from step (4) may be parsed to include the generated coding questions. The proprietary system (A₁) may be asked the initial question, but broken down by region with the corresponding generated coding questions.

In step (6), the results from step (5) may parsed, and a response may be created for the user.

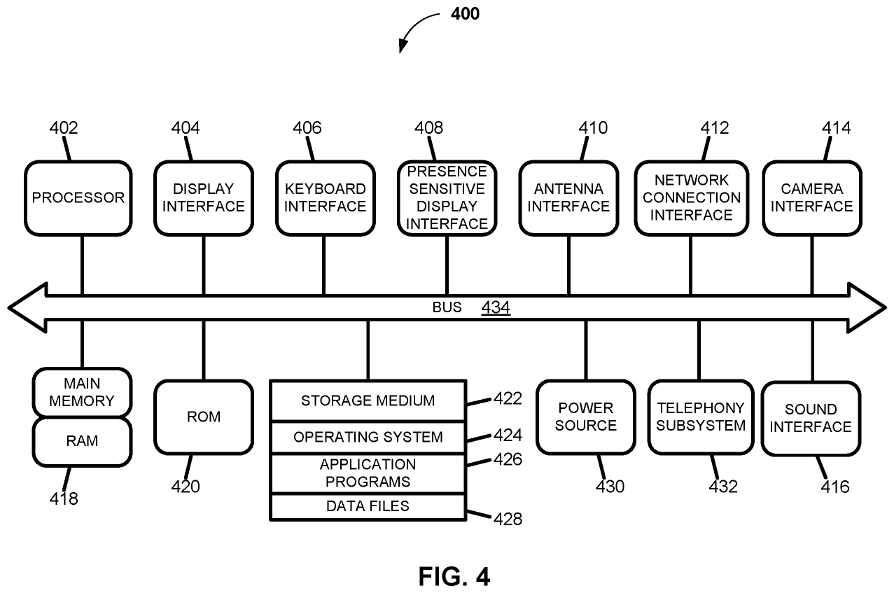

FIG. 4 depicts a block diagram of an illustrative computing device 400 that may be utilized to enable certain aspects of the disclosed technology. Various implementations and methods herein may be embodied in non-transitory computer-readable media for execution by a processor. It will be understood that the computing device 400 is provided for example purposes only and does not limit the scope of the various implementations of the communication systems and methods.

The computing device 400 of FIG. 4 includes one or more processors where computer instructions are processed. The computing device 400 may comprise the processor 402, or it may be combined with one or more additional components shown in FIG. 4. In some instances, a computing device may be a processor, controller, or central processing unit (CPU). In yet other instances, a computing device may be a set of hardware components.

The computing device 400 may include a display interface 404 that acts as a communication interface and provides functions for rendering video, graphics, images, and texts on the display. In certain example implementations of the disclosed technology, the display interface 404 may be directly connected to a local display. In another example implementation, the display interface 404 may be configured for providing data, images, and other information for an external/remote display. In certain example implementations, the display interface 404 may wirelessly communicate, for example, via a Wi-Fi channel or other available network connection interface 412 to the external/remote display.

In an example implementation, the network connection interface 412 may be configured as a communication interface and may provide functions for rendering video, graphics, images, text, other information, or any combination thereof on the display. In one example, a communication interface may include a serial port, a parallel port, a general-purpose input and output (GPIO) port, a game port, a universal serial bus (USB), a micro-USB port, a high-definition multimedia (HDMI) port, a video port, an audio port, a Bluetooth port, a near-field communication (NFC) port, another like communication interface, or any combination thereof. In one example, the display interface 404 may be operatively coupled to a local display. In another example, the display interface 404 may wirelessly communicate, for example, via the network connection interface 412 such as a Wi-Fi transceiver to the external/remote display.

The computing device 400 may include a keyboard interface 406 that provides a communication interface to a keyboard. According to certain example implementations of the disclosed technology, the presence-sensitive display interface 408 may provide a communication interface to various devices such as a pointing device, a touch screen, etc.

The computing device 400 may be configured to use an input device via one or more of the input/output interfaces (for example, the keyboard interface 406, the display interface 404, the presence-sensitive display interface 408, the network connection interface 412, camera interface 414, sound interface 416, etc.,) to allow a user to capture information into the computing device 400. The input device may include a mouse, a trackball, a directional pad, a trackpad, a touch-verified trackpad, a presence-sensitive trackpad, a presence-sensitive display, a scroll wheel, a digital camera, a digital video camera, a web camera, a microphone, a sensor, a smartcard, and the like. Additionally, the input device may be integrated with the computing device 400 or may be a separate device. For example, the input device may be an accelerometer, a magnetometer, a digital camera, a microphone, and an optical sensor.

Example implementations of the computing device 400 may include an antenna interface 410 that provides a communication interface to an antenna; a network connection interface 412 that provides a communication interface to a network. According to certain example implementations, the antenna interface 410 may utilize to communicate with a Bluetooth transceiver.

In certain implementations, a camera interface 414 may be provided that acts as a communication interface and provides functions for capturing digital images from a camera. In certain implementations, a sound interface 416 is provided as a communication interface for converting sound into electrical signals using a microphone and for converting electrical signals into sound using a speaker. According to example implementations, random-access memory (RAM) 418 is provided, where computer instructions and data may be stored in a volatile memory device for processing by the CPU 402.

According to an example implementation, the computing device 400 includes a read-only memory (ROM) 420 where invariant low-level system code or data for basic system functions such as basic input and output (I/O), startup, or reception of keystrokes from a keyboard are stored in a non-volatile memory device. According to an example implementation, the computing device 400 includes a storage medium 422 or other suitable types of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 424, application programs 426 (including, for example, a web browser application, a widget or gadget engine, and or other applications, as necessary) and data files 428 are stored. According to an example implementation, the computing device 400 includes a power source 430 that provides an appropriate alternating current (AC) or direct current (DC) to power components. According to an example implementation, the computing device 400 includes a telephony subsystem 432 that allows the device 400 to transmit and receive sound over a telephone network. The constituent devices and the CPU 402 communicate with each other over a bus 434.

In accordance with an example implementation, the CPU 402 has an appropriate structure to be a computer processor. In one arrangement, the computer CPU 402 may include more than one processing unit. The RAM 418 interfaces with the computer bus 434 to provide quick RAM storage to the CPU 402 during the execution of software programs such as the operating system application programs, and device drivers. More specifically, the CPU 402 loads computer-executable process steps from the storage medium 422 or other media into a field of the RAM 418 to execute software programs. Data may be stored in the RAM 418, where the data may be accessed by the computer CPU 402 during execution. In one example configuration, the device 400 includes at least 128 MB of RAM, and 256 MB of flash memory.

The storage medium 422 itself may include a number of physical drive units, such as a redundant array of independent disks (RAID), a floppy disk drive, a flash memory, a USB flash drive, an external hard disk drive, a thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer-readable storage media allow the device 400 to access computer-executable process steps, application programs, and the like, stored on removable and non-removable memory media, to off-load data from the device 400 or to upload data onto the device 400. A computer program product, such as one utilizing a communication system may be tangibly embodied in storage medium 422, which may comprise a machine-readable storage medium.

According to one example implementation, the term computing device, as used herein, may be a CPU, or conceptualized as a CPU (for example, the CPU 402 of FIG. 4). In this example implementation, the computing device (CPU) may be coupled, connected, and/or in communication with one or more peripheral devices.

Various implementations of the communication systems and methods herein may be embodied in non-transitory computer readable media for execution by a processor. An example implementation may be used in an application of a mobile computing device, such as a smartphone or tablet, but other computing devices may also be used, such as to portable computers, tablet PCS, Internet tablets, PDAs, ultra mobile PCs (UMPCs), etc.

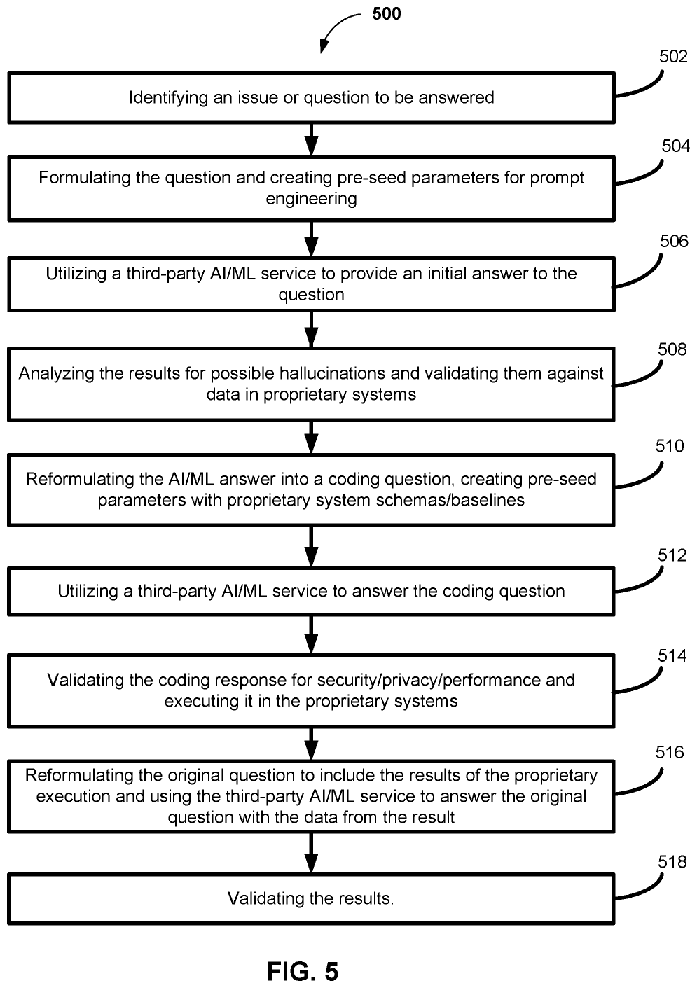

An exemplary method 500 for utilizing AI/ML services to solve business problems while protecting proprietary information will now be described with reference to the flowchart of FIG. 5. The method 500 starts in block 502, and according to an exemplary embodiment of the disclosed technology includes identifying an issue or question to be answered. In block 504, the method 500 includes formulating the question and creating pre-seed parameters for prompt engineering. In block 506, the method 500 includes utilizing a third-party AI/ML service to provide an initial answer to the question. In block 508, the method 500 includes analyzing the results for possible hallucinations and validating them against data in proprietary systems. In block 510, the method 500 includes reformulating the AI/ML answer into a coding question, creating pre-seed parameters with proprietary system schemas/baselines. In block 512, the method 500 includes utilizing a third-party AI/ML service to answer the coding question. In block 514, the method 500 includes validating the coding response for security/privacy/performance and executing it in the proprietary systems. In block 516, the method 500 includes reformulating the original question to include the results of the proprietary execution and using the third-party AI/ML service to answer the original question with the data from the result. In block 518, the method 500 includes validating the results to ensure they meet acceptable quality levels. The method 500 ends after block 518.

In certain implementations, the proprietary systems can include sensitive data and/or algorithms that are not to be shared with the third-party AI/ML service.

In certain implementations, the initial answer provided by the third-party AI/ML service may be analyzed to detect possible hallucinations or errors.

In certain implementations, the coding question may be formulated based on the results of the initial answer. In certain implementations, the coding question may be designed to obtain a more accurate answer while protecting proprietary information.

In certain implementations, the coding response may be validated for security, privacy, and performance before being executed in the proprietary systems.

In certain implementations, the final answer obtained from the third-party AI/ML service may be validated to ensure it meets acceptable standards.

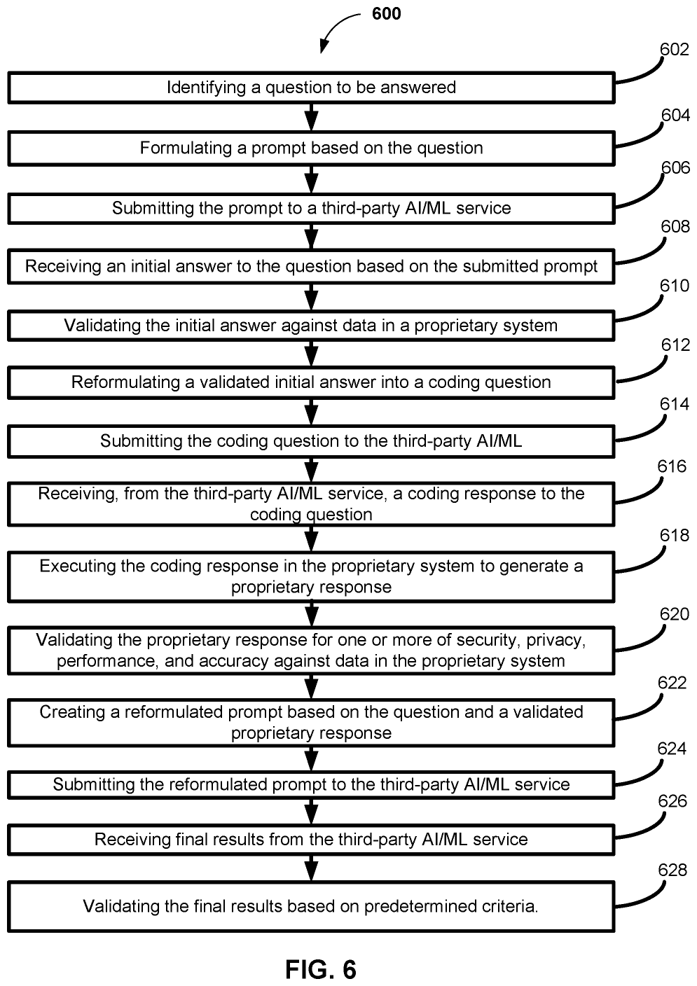

An exemplary method 600 for utilizing AI/ML services to solve business problems while protecting proprietary information will now be described with reference to the flowchart of FIG. 6. The method 600 starts in block 602, and according to an exemplary embodiment of the disclosed technology includes identifying a question to be answered. In block 604, the method 600 includes formulating a prompt based on the question. In block 606, the method 600 includes submitting the prompt to a third-party AI/ML service. In block 608, the method 600 includes receiving an initial answer to the question based on the submitted prompt. In block 610, the method 600 includes validating the initial answer against data in a proprietary system. In block 612, the method 600 includes reformulating a validated initial answer into a coding question. In block 614, the method 600 includes submitting the coding question to the third-party AI/ML. In block 616, the method 600 includes receiving, from the third-party AI/ML service, a coding response to the coding question. In block 618, the method 600 includes executing the coding response in the proprietary system to generate a proprietary response. In block 620, the method 600 includes validating the proprietary response for one or more of security, privacy, performance, and accuracy against data in the proprietary system. In block 622, the method 600 includes creating a reformulated prompt based on the question and a validated proprietary response. In block 624, the method 600 includes submitting the reformulated prompt to the third-party AI/ML service. In block 626, the method 600 includes receiving the final results from the third-party AI/ML service. In block 628, the method 600 includes validating the final results based on predetermined criteria.

In certain implementations, validating the initial answer can include analyzing the initial answer for possible hallucinations or errors.

In accordance with certain exemplary implementations of the disclosed technology, reformulating the validated initial answer can include creating prompt seed parameters based on schemas or baselines of the proprietary system.

In certain implementations, the proprietary system can include sensitive data and/or algorithms that are not to be shared with the third-party AI/ML service.

In accordance with certain exemplary implementations of the disclosed technology, validating the proprietary response can include determining that the proprietary response includes no hallucinations or errors.

In certain implementations, the coding question may be formulated based on the results of the initial answer. In certain implementations, the coding question may be designed to obtain a more accurate answer while protecting proprietary information.

In certain implementations, the reformulated prompt may be validated for security, privacy, and performance before being executed in the proprietary systems.

In certain implementations, the final result obtained from the third-party AI/ML service may be validated to ensure it meets acceptable standards.

In certain implementations, the question to be answered may include identifying an issue to be solved.

Certain embodiments of the disclosed technology may include any number of hardware and/or software applications that are executed to facilitate any of the operations. In exemplary embodiments, one or more I/O interfaces may facilitate communication between the input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction. The one or more I/O interfaces may be utilized to receive or collect data and/or user instructions from a wide variety of input devices. Received data may be processed by one or more computer processors as desired in various embodiments of the disclosed technology and/or stored in one or more memory devices.

One or more network interfaces may facilitate connection of inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth™ (owned by Telefonaktiebolaget LM Ericsson) enabled network, a Wi-Fi™ (owned by Wi-Fi Alliance) enabled network, a satellite-based network any wired network, any wireless network, etc., for communication with external devices and/or systems.

As desired, embodiments of the disclosed technology may include more or less of the components illustrated in FIG. 4.

Certain embodiments of the disclosed technology are described above with reference to block and flow diagrams of systems and methods and/or computer program products according to exemplary embodiments of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented or may not necessarily need to be performed at all, according to some embodiments of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the disclosed technology may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of the disclosed technology have been described in connection with what is presently considered to be the most practical and various embodiments, it is to be understood that the disclosed technology is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

In the preceding description, numerous specific details are set forth. However, it is to be understood that embodiments may be practiced without these specific details. In other instances, well-known methods, structures and techniques have not been shown in detail in order not to obscure an understanding of this description. The term “exemplary” herein is used synonymous with the term “example” and is not meant to indicate excellent or best. References to “one embodiment,” “an embodiment,” “exemplary embodiment,” “various embodiments,” etc., indicate that the embodiment(s) of the disclosed technology so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

This written description uses examples to disclose certain embodiments of the disclosed technology, including the best mode, and also to enable any person skilled in the art to practice certain embodiments of the disclosed technology, including making and using any devices or systems and performing any incorporated methods. The patentable scope of certain embodiments of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The claimed disclosed technology is:

1. A method for utilizing AI/ML services to solve business problems while protecting proprietary information, comprising:
identifying a question to be answered;
formulating a prompt based on the question;
submitting the prompt to a third-party AI/ML service;
receiving an initial answer to the question based on the submitted prompt;
validating the initial answer against data in a proprietary system;
reformulating a validated initial answer into a coding question;
submitting the coding question to the third-party AI/ML;
receiving, from the third-party AI/ML service, a coding response to the coding question;
executing the coding response in the proprietary system to generate a proprietary response;
validating the proprietary response for one or more of security, privacy, performance, and accuracy against data in the proprietary system;
creating a reformulated prompt based on the question and a validated proprietary response;
submitting the reformulated prompt to the third-party AI/ML service;
receiving final results from the third-party AI/ML service; and
validating the final results based on predetermined criteria.

2. The method of claim 1, wherein formulating the initial prompt comprises creating pre-seed parameters for the prompt.

3. The method of claim 1, wherein validating the initial answer comprises analyzing the initial answer for possible hallucinations or errors.

4. The method of claim 1, wherein reformulating the validated initial answer comprises creating prompt seed parameters based on schemas or baselines of the proprietary system.

5. The method of claim 1, wherein the proprietary system includes sensitive data and/or algorithms that are not to be shared with the third-party AI/ML service.

6. The method of claim 1, wherein validating the proprietary response comprises determining that the proprietary response includes no hallucinations or errors.

7. The method of claim 1, wherein the coding question is formulated based on the results of the initial answer and is designed to obtain a more accurate answer while protecting proprietary information.

8. The method of claim 1, wherein the reformulated prompt is validated for security, privacy, and performance before being executed in the proprietary systems.

9. The method of claim 1, wherein a final result obtained from the third-party AI/ML service is validated to ensure it meets acceptable standards.

10. The method of claim 1, wherein identifying the question to be answered comprises identifying an issue to be solved.

11. A system comprising:
one or more processors;
memory in communication with the one or more processors;
instructions stored in the memory that, when executed by the one or more processors, cause the system to perform a method comprising:
identifying a question to be answered;
formulating a prompt based on the question;
submitting the prompt to a third-party AI/ML service;
receiving an initial answer to the question based on the submitted prompt;
validating the initial answer against data in a proprietary system;
reformulating a validated initial answer into a coding question;
submitting the coding question to the third-party AI/ML;
receiving, from the third-party AI/ML service, a coding response to the coding question;
executing the coding response in the proprietary system to generate a proprietary response;
validating the proprietary response for one or more of security, privacy, performance, and accuracy against data in the proprietary system;
creating a reformulated prompt based on the question and a validated proprietary response;
submitting the reformulated prompt to the third-party AI/ML service;
receiving final results from the third-party AI/ML service; and
validating the final results based on predetermined criteria.

12. The system of claim 11, wherein formulating the initial prompt comprises creating pre-seed parameters for the prompt.

13. The system of claim 11, wherein validating the initial answer comprises analyzing the initial answer for possible hallucinations or errors.

14. The system of claim 11, wherein reformulating the validated initial answer comprises creating prompt seed parameters based on schemas or baselines of the proprietary system.

15. The system of claim 11, wherein the proprietary system includes sensitive data and/or algorithms that are not to be shared with the third-party AI/ML service.

16. The system of claim 11, wherein validating the proprietary response comprises determining that the proprietary response includes no hallucinations or errors.

17. The system of claim 11, wherein the coding question is formulated based on the results of the initial answer and is designed to obtain a more accurate answer while protecting proprietary information.

18. The system of claim 11, wherein the reformulated prompt is validated for security, privacy, and performance before being executed in the proprietary systems.

19. The method of claim 11, wherein identifying the question to be answered comprises identifying an issue to be solved.

20. At least one non-transitory computer-readable medium comprising a set of instructions that, in response to being executed by a processor circuit, cause the processor circuit to perform a method of:
identifying a question to be answered;
formulating a prompt based on the question;
submitting the prompt to a third-party AI/ML service;
receiving an initial answer to the question based on the submitted prompt;
validating the initial answer against data in a proprietary system;
reformulating a validated initial answer into a coding question;
submitting the coding question to the third-party AI/ML;
receiving, from the third-party AI/ML service, a coding response to the coding question;
executing the coding response in the proprietary system to generate a proprietary response;
validating the proprietary response for one or more of security, privacy, performance, and accuracy against data in the proprietary system;
creating a reformulated prompt based on the question and a validated proprietary response;
submitting the reformulated prompt to the third-party AI/ML service;
receiving final results from the third-party AI/ML service; and
validating the final results based on predetermined criteria.
